(19) United States
(12) Patent Application Publication
(10) Pub. No.: US 2017/0109140 A1
(43) Pub. Date: Apr. 20, 2017

(54) Method and System for Editing and Generating Syntax

(71) Applicant: Peter Lalka, Aurora, IL (US)

(72) Inventor: Peter Lalka, Aurora, IL (US)

(21) Appl. No.: 14/887,034

(22) Filed: Oct. 19, 2015

(51) Int. Cl. G06F 9/44

(52) U.S. Cl. CPC G06F 8/34

(57) ABSTRACT

The new method and system uses an arbitrary language specification organized as a series of words and characters or a hierarchical list of elements converted to a collection of inline controls to generate and modify any code or symbols using one or more windows. The controls are added to one or more windows depending on the user's choice of how to view/use the changeable controls; inline or in another window that functions as a structured, indented outline so the user can manage controls outside the default editing window. A composite class pattern for expression types and extended controls extends interactivity, and makes a scalable API possible. Word, required value, binary option, ternary option, series option, repeatable and nested, or recursively repeating, expressions are included in the class structure, making any command or syntax possible.

### TECHNICAL FIELD

This disclosure relates generally to building syntax and more specifically, to a computer syntax builder supporting code generation by allowing the writing of primarily source code but also natural language and other use.

### BACKGROUND OF THE INVENTION

The graphical text editor has been the primary tool used for the editing of source code. Text editing with code assistance is the main form of development in combination with the use of templates and forms provided to offer a structured approach that generates syntax. Structure, syntax and style are all handled by a source code editing user interfaces. Object modeling has been combined with source code generation to facilitate the creation of class and object structure.

Tools and applications that assist with code generation use form generation, hints, macros and code blocks. The API's serialize and deserialize data to assist with the development and assistance with existing code. Code generation is limited with these methods. Hints are only made possible by first entering text and building objects, and then the hints may include myriad possibilities, only one of which the developer wants and often already knows. Extended object modeling generates code, but only a framework of classes and simple algorithms and functions. A structured approach using forms inserts code or a higher level code, however the user is faced with instructions available generated arbitrarily and available only as the developer and administrator allow.

The formal, structured use of forms to generate a higher or same level syntax can compound the problem by requiring the repetitious, tedious use of forms and then an arbitrary conversion to another language. These tools are not designed for the highly skilled developer. A possible drawback of these tools is the requirement for familiarity with yet another complex tool and a possibly complex conversion process as user familiarity and expertise increases. The application providing the formal process may not require a low level developer's full knowledge of the application's configuration, but it will require expertise somewhere in the chain of developers and managers responsible for the resulting code's testing and execution. Someone must maintain the predefined commands, which could be just as large a list as what is possible with inline text hinting methods.

Inline text hinting is generally known to create problems with CPU and memory usage when meta data and source code version management are incorporated into the code hinting lists. The same problems restrict the use of dynamic behavior with form controls that assist with selection of global objects or any other elements included in a project. Inserting code blocks only provides a predetermined set of text to complete and then format.

Facilitating code generation is difficult when the process is formal and structured, and it has been observed that the difficulty of typing thousands of lines of code and the cost in relation to expectations is an obstacle to project development. The time saved converting predefined commands may be significant, but the conversion is still an arbitrary one, and may still require typing in thousands of lines of code which is still is tiring and above all tedious when an algorithm proves inefficient. At some point there may be an algorithm or source code outside the scope of an existing template, and a developer, even if the algorithm is already known and diagrammed, must code it before it becomes a predefined command somewhere. So the convenience with a formal, structured method must be fully engineered before it is realized.

### BRIEF SUMMARY OF THE INVENTION

The user will open the application and then most often open a stored language specification that is part of an implementation. A language specification is most generally stored as a tree data structure. The language specification will open immediately after, or there can be a button to convert the language specification to form controls. When the controls are created and added to window that has a default flow layout, the controls will be listed sequentially with equal spacing between them. When the option controls are clicked phrases appear as part of a collection either associated with the control by a name or key or a collection object that is part of an extended control. The images explain the latter method with a reference to a collection and the collection is accessed by calling one of the control object's functions. There are many other ways to handle the collections in a way that does not resemble a tree, but for the explanation it is a very efficient method of showing how an implementation works.

When the user has a window open with controls and there are controls visible to manage options in the language definition or specification, the user will see the option controls listed in a separate window if the user has chosen to separate option controls and simple, language element controls. The controls can, by default, be contained in a single editing window. The buttons and commands to add or remove repeatable expressions can also be listed and indented according to the collection they exist in. This can be done simply by using a hidden collection to manage all of the controls and iterating through it as the default collection in the build and remove functions shown in the diagrams. When an option control is changed and an option made active, the off screen collection is changed and the iteration is run again, with controls removed and added to the extent the developer is willing to add in and remove logic to simplify the algorithm or make the process more efficient.

Changing options will be the most common activity and it will lead to a demand for options to change the handling of dependent controls that are hidden and shown again. Showing an option after it has been hidden and resetting the sub controls to a default state may lose work. There will be options for the user in menus or in context menus to reset the controls, keep the previous state of the controls, or set custom state options for the instance and/or future use. Implementing these options only requires eliminating steps from the included flow diagrams that show how to clear controls from the viewing window and control collections. Controls may just be removed from the screen and not from the collection.

Extending the interface with graphics that give controls more functionality to the user is simple. The included class hierarchy gives the developer simplified options for extending different architectures to implement any kind of behavior involving animation, drawing and referencing other controls to change their properties. Mouse down, click, click and drag, mouse up, and any other events are programmable because of the ability to extend features and assign functionality in a parent object's constructor.

The immediate benefit of using an application like this is more obvious with specialized programming languages that use a consistently formal structure with many standard characters and reserved words inserted into the command. TSQL is one example where this application would create an immediate increase in productivity with little customization. Creating complexity that often requires assistance and high levels of skill to maintain because of hours of typing that in turn require steady, high levels of focus and concentration, is now much faster and simpler with a point and click method.

Two of the more difficult to implement algorithms, nested expressions and nested functions, are covered in the drawings. These are required to avoid a stack overflow when using a tree structure to store a language definition and would not pose a problem with other methods of storing a language definition as a series of statements To avoid the stack overflow a parent node can be added to another node before it's the child nodes are added. An alternative is to use a nestable expression object set as the child node, and when the build function is called to convert the nodes a function is called to fill in the empty node's top level language expression before the top level language expression nodes are converted.

The flow diagrams and views, as will be shown, give one implementation in which a class structure that supports controls and a class structure that support language expressions can consistently manage a series of controls and a structure laid out in a specification. A simple composition of the controls is given along with possible guidelines for the kinds of expressions that can contain others, understanding the composite pattern in use for both controls and language expressions.

As an optional feature, for a user who wants to parse and check expressions edited in a window because there is a choice not to automatically name variables, the variables may contain incorrect values, or the program may throw errors, a parser can be called by incorporating simple commands that send commands to the parser after the extraction of the syntax from the controls The result can be sent back to the application to display. Many code checking applications are available for purposes similar to this invention.

An API can extend the functionality to any graphical editor and export source code in any format the native user interface for editing code makes use of. A developer can use the invention's features to switch to a necessarily easier format to program statements in an unfamiliar coding language or typing in dozens of reserved words and/or repetitive text, as with TSQL, makes it the efficient format for a multi-tier application developer. Extending the use of the API can put the statement in a floating window or a docked window. The editing configured to take place in one window, there is no reason a graphic element in the editing window representing a program command could not open a window that uses the same API with other symbols and a lower or higher level language definition or specification for that instance, representing other programs that in turn could be opened with additional instances of the application or other docked windows.

Further testing the use of the invention may lead to an optional systems of sequentially listing controls. Adding connectors or symbols in between elements on the screen is easy to implement as the controls/windows/panels/images can be handled in another collection. A custom layout and standard events to move individual controls or series of controls are easy to implement. There will be the capacity to zoom out or use a menu and use drawings or images to refer to any number of in process or complete statements. Each object on the screen could represent a statement with a simulated flow diagram, UML or any of the methods that represent business logic. The options that can be extended to controls can position the controls in any direction relative to the former or the virtual parent control, logging project progress and even versions of programs. Essentially the object diagramming

There are two examples included in the description that serve to illustrate how this system and method are a complete departure from the previous methods of generating syntax. These examples should help the differentiate the invention and set it apart from prior art.

Whereas there are already systems with a two or three step process to generate the same or higher level syntax and the code is automatically generated using an arbitrary, predefined set of instructions, this invention is literally a hands on approach with no separation between what a user sees and the actual language definition. In the two or three step process a form is generated and placed arbitrarily in a graphical interface to fill out, a common method for data entry but with different output on an otherwise unchangeable window of statements. In the other approaches a user must manually add parameters, and with this method no parameters are ever used to generate syntax. Also notable, extraneous controls are not included anywhere on the viewing window or other windows. In fact, there is no separate procedure to add any information any information anywhere with any extraneous, context or process dependent controls. Changes are made to the editing window directly with no extra forms required to eliminate the tedious and repetitive nature of filling them out.

Furthermore, the purpose of the invention is not only to avoid potential user error by filling in reserved words automatically and auto naming variables as obvious features, but first and foremost to offer hyper functional syntax development. In essence this is still, and maybe even moreso, free form development and errors are possible when confined to making changes in the editing window. Because of the elimination of the processes used for formal methods, it's uses as a hyper dynamic development method extend beyond the rigid top down, left to right systems developed thus far.

There are always errors with free form development, but even with potential errors, the speed at which a programmer can develop and test outweighs the few avenues of error which have always been reasons to avoid free form programming. This will be seen in the practical outworking of the two previously mentioned following examples. With a little forethought, this method becomes an obviously innovative approach and leads to other, more innovative and impressive implementations not adequate for an example and explanation.

### BRIEF DESCRIPTION OF THE SEVERAL VIEWS OF THE DRAWING

1. Image 1 is an example of the use of the application to build syntax.

2. Image 2 is an exemplary depiction of a display that may be used as a syntax building interface.

3. Image 3 is the first page of a flow diagram of the process to convert a language expression to form controls.

4. Image 4 shows a partial flow diagram consisting of a series option expression and a repeatable expression converted to controls.

5. Image 5 is an exemplary depiction of a statement converted to form controls that a user may change.

6. Image 6 is a flow diagram of the changes a user can make to text box, binary, ternary and series controls.

7. Image 7 is a flow diagram when a “More” or “Less” button is used, and the beginning of the flow diagram showing how controls are removed.

8. Image 8 is a continuation of the composite control removal and the beginning of simple control removal.

9. Image 9 is a continuation of simple control removal and the removal of extra repeatable expression control sets.

10. Image 10 is an exemplary depiction of a series of controls ready for a user to change in an editing window.

11. Image 11 is a flow diagram of the process to add a set of controls that represent a repeatable expression using a “More” button.

12. Image 12 is a continuation of the flow diagram of the process to add a set of controls that represent a repeatable expression using a “More” button.

13. Image 13 is a continuation of the flow diagram of the process to add a set of controls that represent a repeatable expression using a “More” button.

14. Image 14 is a continuation of the flow diagram of the process to add a set of controls that represent a repeatable expression using a “More” button.

15. Image 15 is a continuation of the flow diagram of the process to add a set of controls that represent a repeatable expression using a “More” button.

16. Image 16 is a continuation of the flow diagram of the process to add a set of controls that represent a repeatable expression using a “More” button.

17. Image 17 is a simplified class diagram of the controls, the naming or labeling of those controls, and a depiction of how controls' option(s) can be organized.

18. Image 18 is a continuation of the simplified class diagram of controls, showing the repeatable expression control and the joining expression control.

19. Image 19 is a class hierarchy showing language expression and language element class as base classes or interfaces.

20. Image 20 is a depiction of the use of language expression classes and which types of expressions are added to which.

21. Image 21 is a depiction of one of the many possible class hierarchies that supports controls and collection management with the graphical controls extending the functions and properties of the composite language element control class or interface.

22. Image 22 is a depiction of a label or text box's constructor.

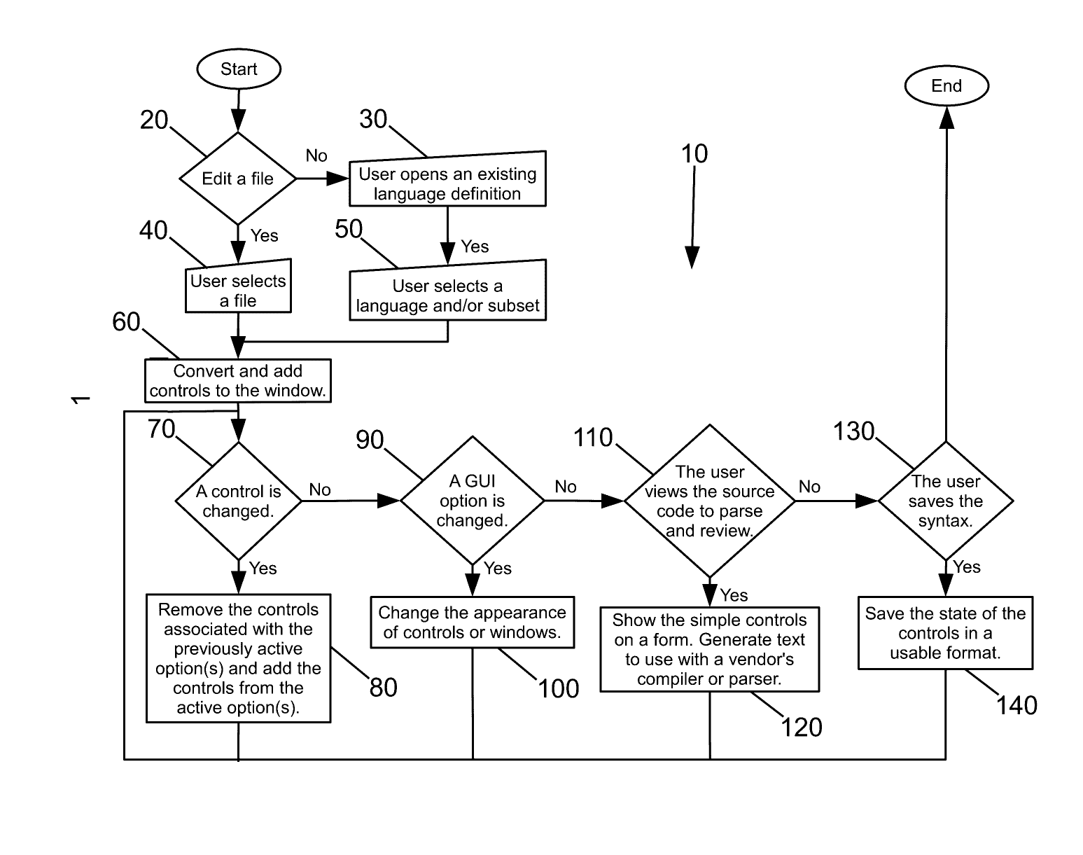

23. FIG. 1 is a depiction of a non required expression control class' constructor.

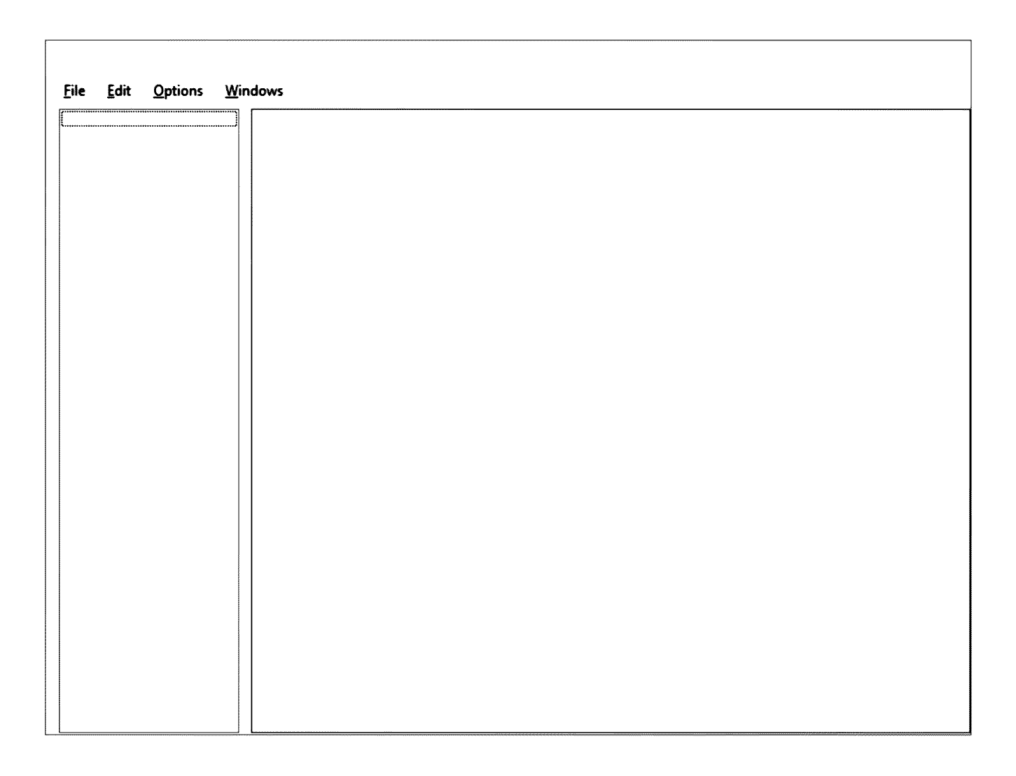

24. FIG. 2 is a depiction of an arbitrarily conceived binary control's constructor.

25. Image 24 is a flow diagram showing the use of the binary control.

26. FIG. 3 is a depiction of a required option expression control's constructor.

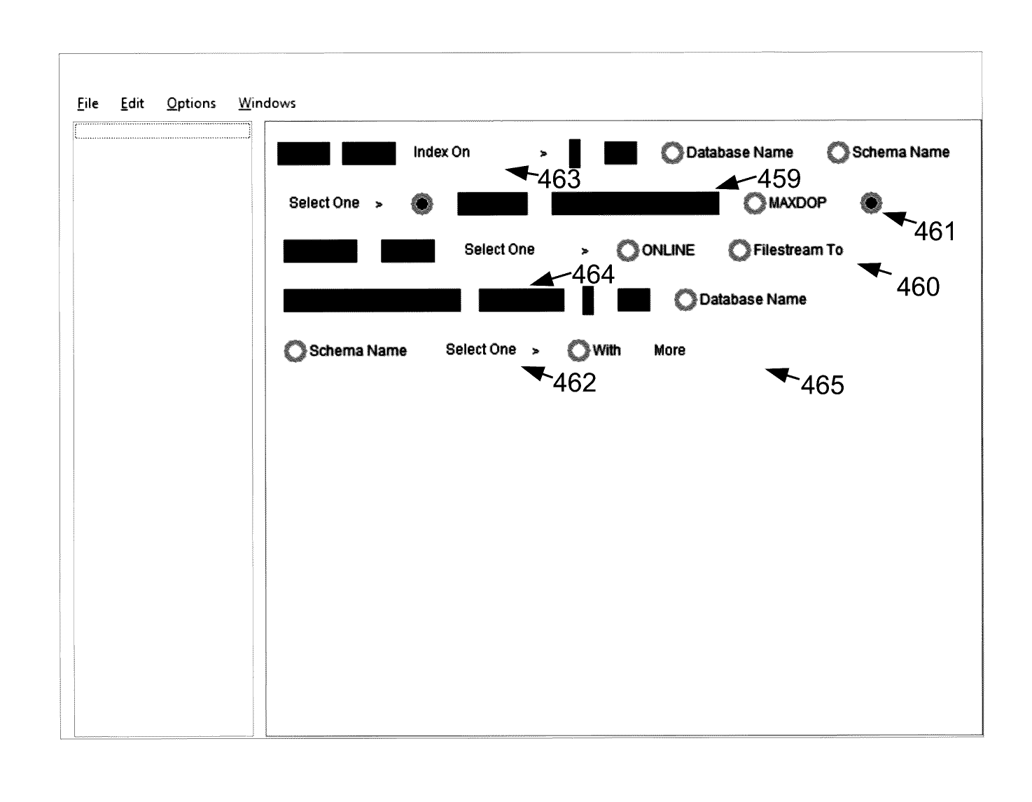

27. FIG. 4 is a depiction of an arbitrarily conceived ternary control's constructor.

28. Image 27 is a flow diagram showing the use of a ternary control.

29. FIG. 5 is a depiction of a series option expression control class' constructor.

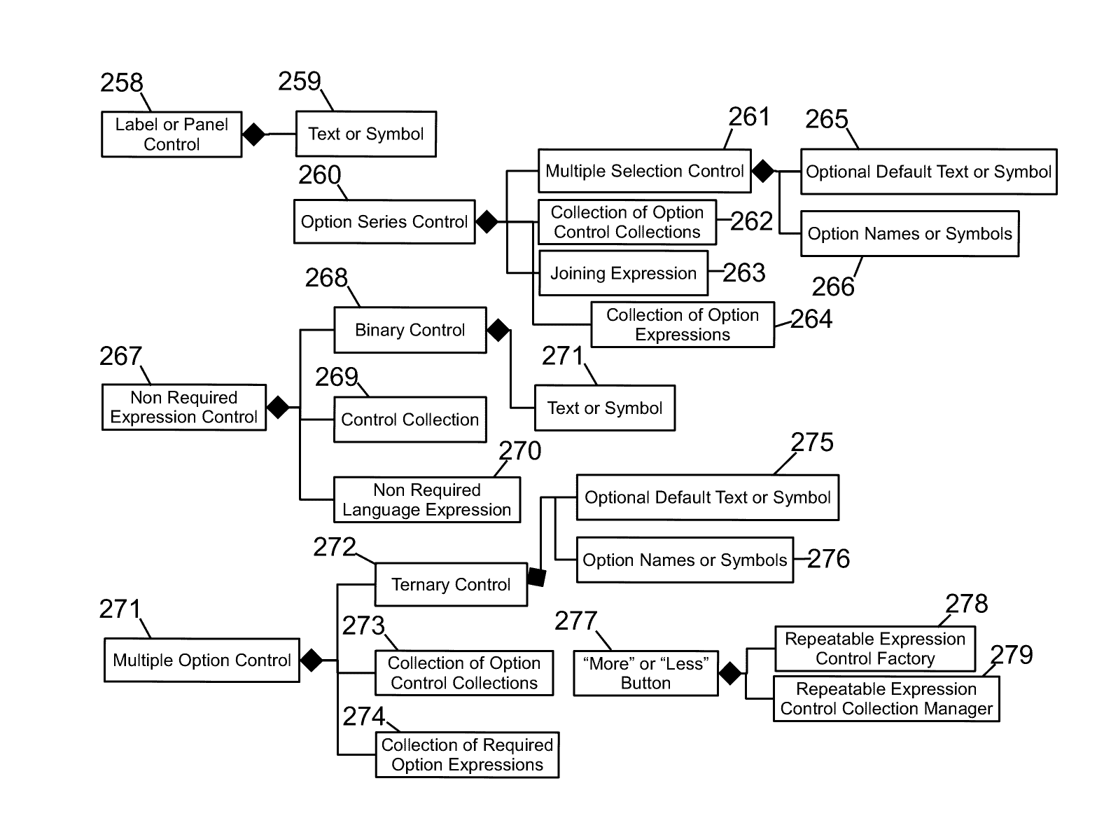

30. FIG. 6 is a depiction of an arbitrarily conceived series option control's constructor.

31. Image 29 is a flow diagram showing the use of the series option control.

32. FIG. 7 is a depiction of a repeatable expression control's constructor.

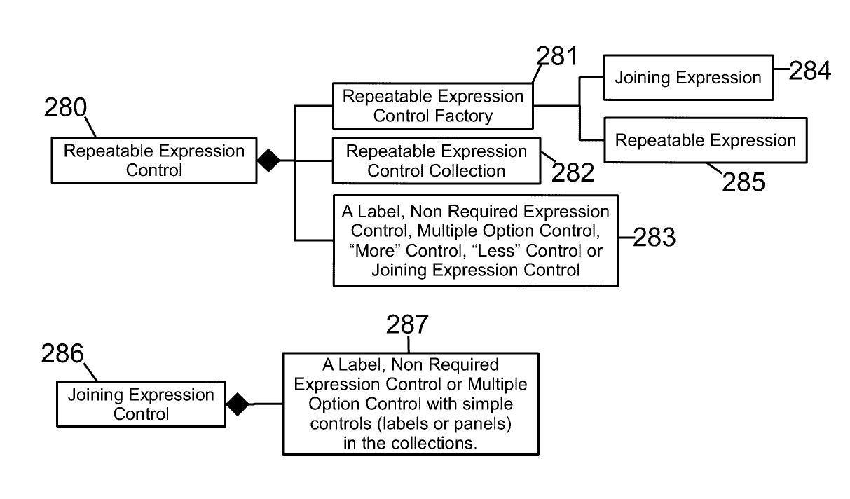

33. FIG. 8 is a flow diagram that summarizes of the use of a “More” control.

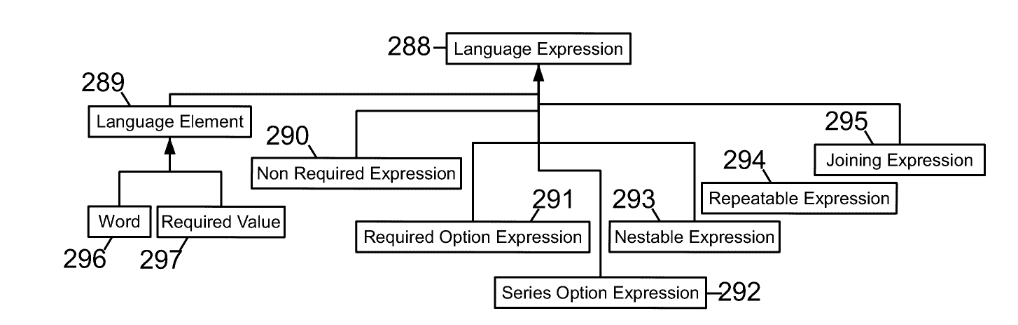

34. FIG. 9 is a flow diagram that summarizes the use of a “Less” control.

35. FIG. 10 is a flow diagram that summarizes the use of shortcut keys to execute instructions.

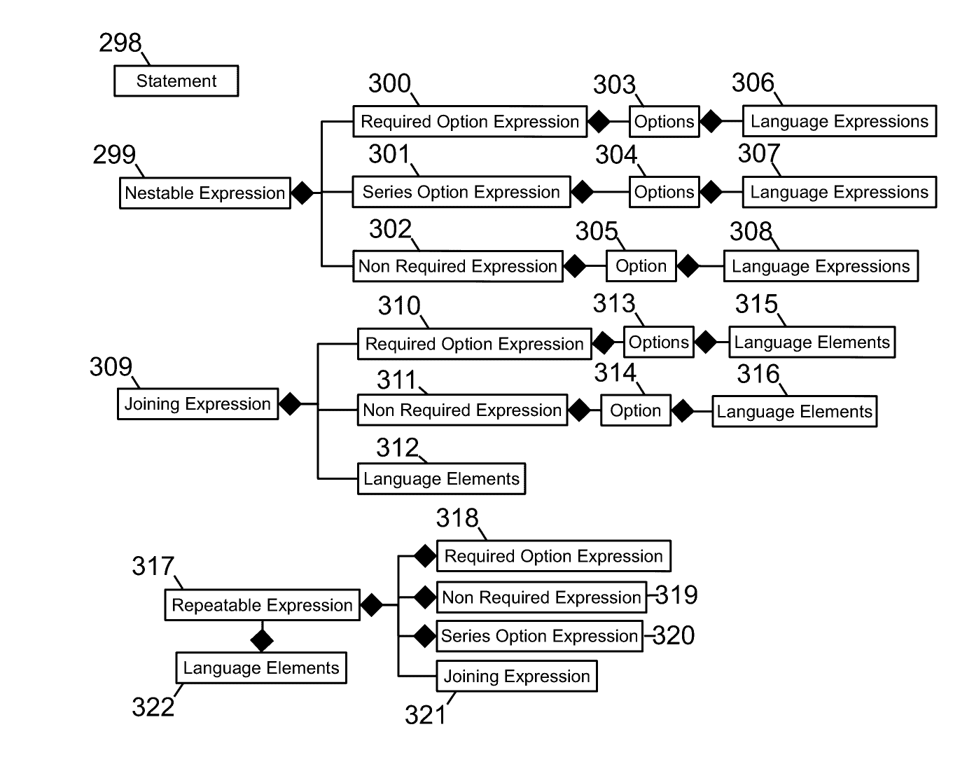

36. FIG. 11 is a flow diagram showing the use of changeable application options.

37. FIG. 12 is a flow diagram that summarizes the use of the command to open a file with a language specification.

38. Image 31 is a flow diagram that summarizes the use of the command to save a new file.

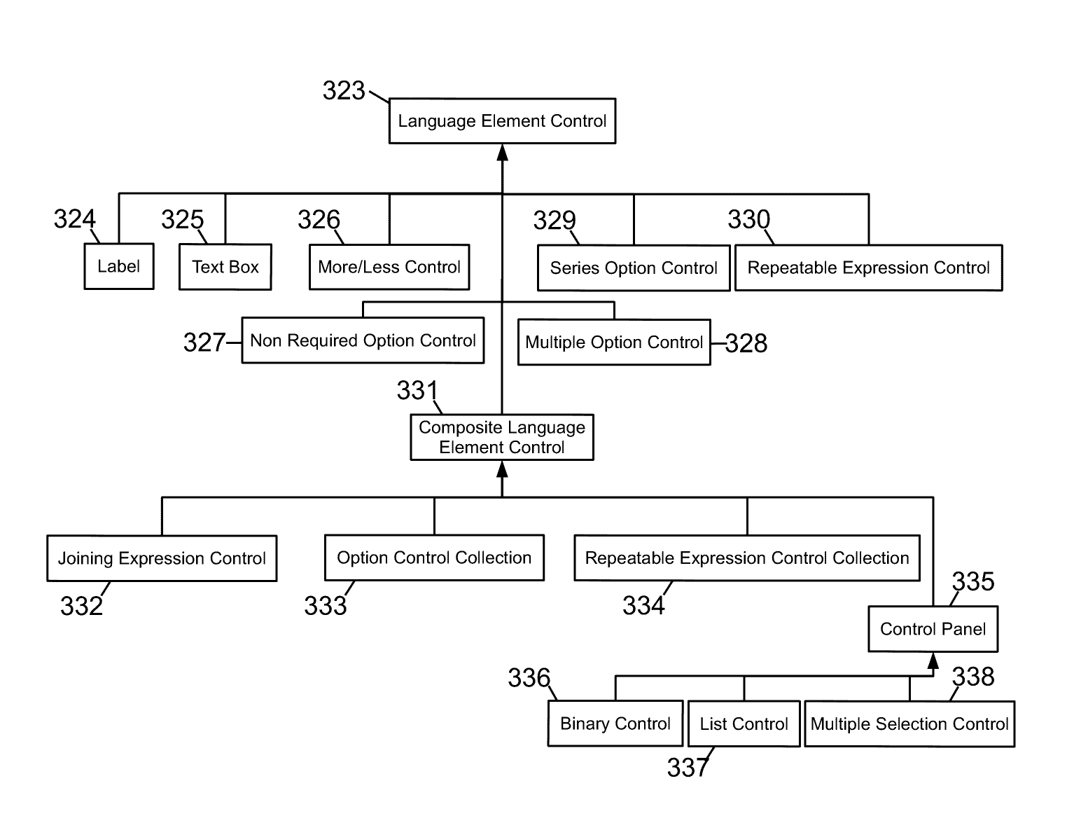

39. FIG. 13 is a flow diagram that summarizes the instructions executed to change the UI configuration for editing.

40. FIG. 14 is a flow diagram that summarizes the use of option that change specific or general control appearance, interactivity and reset options for complex controls.

41. Image 34 is a flow diagram that shows the instructions executed when the user presses the tab key.

42. Image 35 is a flow diagram that summarizes the use of extended interactivity with repeatable expression controls to groups sets of repeatable controls together visually.

43. Image 36 is a flow diagram that summarizes the use of the class hierarchy to include nested functions.

43. Image 37 is a flow diagram that summarizes the use of the class hierarchy to build complex conditional statements.

44. Image 38 is a flow diagram that summarizes the conversion of controls to a usable text file.

### DETAILED DESCRIPTION OF THE INVENTION

The application is a system and method of syntax building and generation with form controls converted from the expressions and language elements a language definition or specification.

The language specification can exist in any text format with any type of formal structure. Because a language specification is easily organized as a set of tree nodes, the algorithm provided is meant to work for any type of hierarchical format. However, adjusting the algorithm to handle a serial text format with symbols or punctuation to enclose the different types of options necessary to build the desired source code or text is an easy change to make and varies little from the algorithm provided.

Optional phrases are included as binary controls, a language expression or element that could be any one of a list will show as a ternary control and a series of options separated with a character like a WITH clause in TSQL or VBScript translates to a series option control, a combination control. Expressions that can be repeated in sequence are converted to controls and optionally followed by a “More” button and/or a “Less” button to create more or fewer sets of the controls. The manage control buttons can be replaced with context menus that insert controls after the set of controls used to click and show the context menu.

The sub expressions that are converted can be referred to directly by the controls, or there can be drivers and interfaces that link the expressions to controls. This is a choice by the developer. The ability to associate sub expressions make the conversion back to a language specification an easier task.

As proof of concept there is further explanation provided to explain how the controls can solve the programming challenges other applications are designed to facilitate or have tried to facilitate with inline text hints. The nested function sequence where a the result of a function is a usable value by another function, shown in image 37, and the complex conditional statement with multiple conditions, boolean operators and bit-level operations is solved in image 38. The creation of the sequences of language elements for these two programming hassles is faster than most methods because there is no required text or right click and choice of an option, and even on touchscreen devices it is easier to handle the highly structured syntax, especially when combined with rules that indent, filter and highlight controls. What the user sees is purely point-and-click with no reserved word typing, formal structure to work through to fill values and the potential to automatically name variables. There is no CPU and memory intensive algorithm to determine the correct time and place to suggest the next phrase.

Image 1 is the flow diagram depicting the use of the the application. The user opens the application and chooses to use an existing specification or open a file in context 20. The user can select an option to use an existing, built-in language specification 30 where the controls could be hard coded or to open a file with a language specification organized hierarchically or serially 40. The user choice is covered in FIG. 12.

If the user chooses to use a predefined specification there will be a list of existing, hard coded specifications, although these could be saved as text files. This process is part of context 50. If a user selects a file the specification is converted using the flow diagram in images 3 through 4. Opening an existing language subset could just result in a construction of predefined controls and the addition of those controls to the window. The conversion for a tree organized specification, hard coded or not is context 60 and defined in the previously mentioned flow diagram.

When user changes a text box or an option control in context 70, functionality shown with a flow diagram in image 6 handles the event. The change of the control and any related controls represented by context 80 is shown in images 7 through 9. There are common options to edit objects in windows like shortcut keys, covered in FIG. 10. The “More” management control is explained in FIG. 8 and the “Less” manage control is explained in FIG. 9. The generic aspect to the visual control leads to an explanation of how an arbitrarily designed control would work. The construction of a label or text box is covered in image 22. The construction of a binary control is shown in FIG. 1 and FIG. 2 and the process of changing the visual control is covered with a flow diagram in image 26. The construction of a ternary control is show in FIG. 3 and FIG. 4 and the use of the visual binary control is shown in image 27. The constructor for a series option/combination control is shown in FIG. 5 and FIG. 6 with the handling of a change event shown with a flow diagram in image 29.

There may be a choice to change the appearance of controls or the windows used to edit or manage the controls in the editing window. The change is represented by context 90 and the instructions to change the appearance are part of context 100. The instructions to change the appearance after a change to an option are covered in FIG. 11, FIG. 13 and FIG. 14. Context 110 is the event that is thrown when a user chooses to preview text. Context 120 represents the context in which the controls are converted to a text or other type of preview. This is briefly explained in the following paragraphs.

A user can make a choice to save the file in context 130, covered in image 31. The conversion to a file in context 140 is explained in image 38 with a flow diagram.

Image 2 is a possible user interface for the application with an optional window for the option controls on the left and a main editing window. The menu options are included for any of the contexts listed.

Image 3 shows the beginning of a conversion process for a tree of language expressions and language elements, also another possible way of storing a predefined language specification. The function call in block 141 includes instructions to convert only the top level nodes in the tree. This leaves complex controls with options and no associated collection of controls for those options. These collection are built when the user selects an option and the collection is determined to be empty. The if statements to determine the type of conversion; a word, 142; a required value, 144; a non required option, 146; a required option, 148 or a delimited set of options, 150, and the blocks proceeding to create a label 143, change a text box 145, change a binary control 147, change a list control 149 and a series option/combination control 151 contain the instructions to create the control and add it to the collection.

If the expression is a repeatable expression the if statement 152 returns true and the function block at 141 is called again with the repeatable expression as an argument. The top level nodes of the repeatable expression can be converted by calling the function again with the repeatable expression as the parameter, or iterating through the top level nodes and using the same conditions already covered. After the conversion of the repeatable expression language elements, the instructions to add buttons to add or remove series are added at block 154. The construction of the “More” and “Less” buttons are covered later.

Images 6 through 9 refer to context 70, the use of controls to change a statement. The user clicks a control or a changes a control and the type is determined. It is a text box 159, a binary option 161, a ternary option 163, a series option 165, or a button to remove or add a set of repeatable expression controls 174. The instructions for block 160 change the text of the control. Block 162 changes the binary control state and appearance when the control's label should be removed from the panel. Instructions for block 164 change the active option of a list control. Instructions for block 166 change the list of active options for a series option control. The instructions in block 175 handle the addition of a new set of repeatable expression controls by using a function shown later in the description.

If the control is a “More” or “Less” button a function is called the function call in block 206 is made.

The use of a class hierarchy to implement repeatable expression controls for the grouping of sets of repeatable expression controls extends any kind of functionality to the grouped sets including user location changes, mouse events and any interactivity to highlight the control or the group of repeatable expression controls. This is a less common feature in coding and text applications, and there are applications that group syntax visually, but for this application it is a necessary feature and shows a marked improvement over previous applications that only use formal process to edit and change sets. The mouse movement and the use of data structures give the user the ability to drag and switch the positions of groups of repeatable expression controls as an optional feature. Selecting every control in a group of repeatable expression controls only requires a recursive call to list every control and what could be referred to as every sub expression control.

Another algorithm to select controls uses an updated index, updated when options are chosen where an if statement determines if the parent/option control is part of a repeatable expression and the control's index in the window's control collection, if it is greater than the parent/option control's current control marked as last, has it's index marked as the repeatable expression control collection's last index. The first and last control's indexes are used to easily find the set of control's that must be moved or highlighted.

The controls to add sets of these controls are optional because of the ability to extend graphical effects since a context menu with options to remove or add can be substituted. The algorithms were included because of a need for a literal point-and-click method and therefore are included as the best implementation.

The controls and expressions not marked off for a series of repeatable expression controls are the joining expression control and the “More” or “Less” button. At this point it may be unclear how these set management controls are handled in collections. These won't highlight or move unless they are part of a repeatable expression that contains the parent/option control. They belong to the parent/option control's repeatable expression control collection and the parent/option control's collection; to two collections. This logic is handled by block 154 in which the control is created, and then if the test to determine if the parameter expression is a repeatable expression 155 returns true, it is added to the parent expression's repeatable expression control collection in block 157. It is added the to collection and window if there isn't a parent repeatable expression in block 156.

The function to add controls tests for more in the iteration at 158 and ends if there are no more controls in the collection.

Image 5 shows the result of a conversion with labels, required values, non required option controls and ternary controls. An active binary control has no label, since the phrase or language element is added to the window in this case, although a surrounding box for controls could be added to group the dependent controls, an ending symbol included or the controls set apart in some other way. The labels are iterated over with the required values to get a preview of the syntax as text. An example of a label is the control labeled 459. An inactive binary control is listed as 460. An active binary control is listed as 461 and the label “WITH” has been removed. The resulting controls that are not in the other set following are dependent controls for that non required option control. There are several required option controls, with an unused control at 462, and a used required option control at 463. The image also depicts the use of a repeatable expression control with a joining expression control including on a label at 464 and a “More” button at 465. Clicking the “More” control would provide another joining expression control and another set of controls.

Almost all of the effort using the application will involve changing controls. Context 70 is explained in images 6 through 9. The events tied to the controls will call functions handled by the controls themselves or a rendition of a factory. The controls when click must be changed to show if an option they manage is active, and then remove or add graphics from the control to further indicate the change. The controls that are associated with the option are added or removed based on the selected state of the option.

For this implementation, a function receives the event and determines the type of component using if statements. An if statement, condition 159 tests for a text box and the text is changed. This is implemented by events passed to a custom control that handles text. The custom control enforces naming conventions, checking for the correct characters and the position at which the character is typed. These instructions are handled by block 160.

A binary option is determined by conditional statement 161 the state is changed to the opposite value at block 162, and then controls are hidden or shown based on the current active state of the binary control. Any of the complex controls that handle options proceed to block 169 after separate conditional statements. The logic for the conditional statements could be combined, however for this implementation, it is possible to use separate conditions. The explanation of how processing changes for these complex controls is explained in the next paragraphs.

The class composition diagram in image 17 shows the composition of the non required expression control, 267, with a visual control 268, a default name 271, the control collection 269 and the associated expression 270 and the multiple option control 271 that references a ternary control 272, a collection of control collections 273 and a collection required option expressions 274. The series option control/combination control 260, it's visual control 261, option control collections 262, the joining expression that separates the options 263 and the labels for the visual control 265 and the options 256. The series option control 264 has references to a visual multiple selection control 261, the visual controls has a default name 268, and names for each option 269.

Image 17 and 18 show a summarized view of the composition of controls available in the editing window, intended to show how collections and data are referenced by each type of control. It is useful when considering how control collections will be referenced and used in functions.

The label and text box do not use any algorithms to update any data. So label or panel 258 and the default text/image/symbol 259 is not included in any of the algorithms. The control management buttons are also not considered complex controls. These only consist of a button or clickable area 277 with references to the control management objects, the repeatable expression control factory 278 and the repeatable expression control collection manager 279.

The repeatable expression control 280 is only a container, parent class or an interface for the editing control 283. The objects referred by the control manage manage objects are included, the repeatable expression control factory 281 and the repeatable expression control collection manager 282. A joining expression 284 and repeatable expression 285, are saved for the conversion function.

A joining expression control 286 can contain complex controls 287, so it is included in some algorithms, although the implementation of the complex controls is simplified to only include language elements for this description.

The visual controls 261, 268 and 272 are changed, altering the active state of options. The containing or parent control object, 260, 267 or 271 is used to find the collection in the case of a binary control 269 or a group of collections 273 for a ternary control or 262 for a combination/series control. The control collections can be passed to a function or reference variable within a function that normalizes the objects as a collection of collections. A loop iterates through the collections and processes through the controls to remove them if the option, in the case of a binary control, or any option was previously set as active, prior to the changes made by the user. The previous active state of an option can be stored as part of a control collection or an object that handles the option's corresponding language expression. These can be set to mirror the values in the graphical control as the iteration proceeds through each previously active collection and removes controls.

After the if statements at 167 and 168 are evaluated, if the result is false, a function with several sets of instructions is called in image 7 at block 176. The series of iterations is simple to explain. First, an iteration is performed to remove the complex controls from the collection that is passed as a parameter to the function call at block 176.

What the series of iterations accomplish is not readily apparent. The summarized version of the flow diagrams in images 7, 8 and 9 is that three iterations are run through the controls in the collection. The first iteration through the controls removes composite controls; the non required option control, the multiple option control and the series option control and all of the controls that are part of the active options. The second iteration removes all of the controls that are part of repeatable expression control sets. The third iteration finds each repeatable expression control, identifies the series they belong to and removes the extra sets of collections, any after the first. Another way to understand it is that the composite controls and each virtual child control are removed first from the window but not the collection of controls passed as a parameter. This leaves only simple controls in the collection unchecked. An iteration is run to find any repeatable expression controls which are removed from the window and the collection of controls if they are part of a set of repeatable controls after the first set along with corresponding “More” button, “Less” button and any control that is part of a joining expression for that repeatable expression control collection series.

Removing controls is fairly simple understanding that a recursive function can remove controls from a window easily, and that controls can exist as part of hidden controls' collections when not removed from the control collections. it should be remembered that whenever a control is changed, the new controls shown are part of that control's collections. When a repeatable expression series is added to, those controls are not only part of the associated control's option collection but also the repeatable expression control collection series. This makes iterating through controls efficient.

This is the process where any control that has added graphics, tracking or interactivity can be identified and the objects, references and graphics can be removed. Removed controls must have any added interactivity removed from the window, and the conditional statement to determine if the interactivity must be removed can be extended with additional conditional statements to determine if the control inherits other properties.

The process begins by executing an conditional statement that decides if the control is a repeatable expression control at step 177. If the result is yes/true there are instructions in block 178 to get the referenced control. A conditional statement is evaluated at step 179 to determine if the control is a non required option control. This is followed by another conditional statement at step 180 to determine if the control is a multiple option or series control. If the control is any of these complex controls the check for a repeatable expression control as a parent of the control is made at step 181 for a non required option control and if the control is a multiple option control or a series option/combination control the conditional statement at step 182 performs a similar operation. For both controls the interactivity is removed if the control is visible, in block 183 for a non required option control and in block 184 for a multiple option or series option/combination control.

Then the conditions to determine if the control is a non required control or a complex option control. Again, the instructions that reset the controls to a default state and remove the control could be combined so that a generic implementation of a reset function would reset simple and complex controls to an arbitrary default setting if resetting the controls is chosen as an option; it isn't required. The instructions to reset a non required option control are part of block 185 where a name or label for the control is added back to the visual control. The control is removed from the window in block 186. After that, the function is called again for the controls in the controls collection at block 187. For the complex controls, there are instructions to reset the control to a default state and to remove any joining expression controls from a series option control collection if preferred at block 188. The control is removed from the window 189 and then the function is called for each previously active option 190.

When all of the recursive calls to the function are completed and the last control has been checked, the condition at 191 is satisfied for the first call of the function and the function returns at block 192. The next iteration through controls begins. It removes the controls that exist as part of any more than one repeatable expression control set. The complex controls from those sets have already been removed from the window, so only the simple controls are checked and iterated through using instructions at block 193. If the control is a repeatable expression control 194 the child control is taken 195 is checked to see if it is a “More” or “Less” control 196, if it is not in the first set of repeatable controls 197 and if it part of a joining expression; if it's enclosed by a joining expression control 198. If the control is a repeatable control, then it's interactivity is removed 199, and then the control is removed from both the collection and window 200.

The two paths for simple and complex controls merge and the repeatable expression control is removed from the collection. The block 201 checks for another control and if there is no other control in the collection, another iteration begins to remove the extra sets from the repeatable expression control sets, an option also configurable by the user, since the controls do not have to be removed. When a user selects to change the option selection, the work could be saved, with only a removal of controls from the editing window, and then a recursive function adds the controls back to the window immediately after the option control's active options return to the same configuration. The algorithm was complex enough to justify adding it in as an example.

The procedure to remove the extra sets of repeatable expression controls begins at block 202 where an iteration begins through the controls still in the collection. The controls have already been removed from the option control's collection and the window An evaluation is performed at block 203 to determine if the control is a repeatable expression control. Block 204 represents instructions to get the collection of repeatable control sets associated with the control. This is performed by referencing a factory or control collection set manager from the control and then referring the sets themselves. Instructions are executed to clear the array of any more than one set. If there are no more controls determined by a condition at block 205, the iteration is complete.

One of the challenges to making an editing application like this viable is the ability to dynamically add controls with already different algorithms for formatting to collections that are transformed by properties that must be translated to the option collection. For example, if a parent option control is a part of a repeatable collection, and a control in it's option collection has in it another option control with another repeatable expression, how can the correct interactivity for both repeatable expressions be maintained even with the “More” or “Less” control and the joining expression controls which will have only the interactivity of the associated option control itself, but will be contained in the option's control collection and referred to by the repeatable controls in that option's control collection.

The difficulty is overcome by using a few simple rules and then translating those rules into a still relatively complex set of programming logic. The first rule is that any control or control contained in another control's options that is not part of any other repeatable expression control set is added to the window with a reference to either the option control's or repeatable expression's associated repeatable expression control factory and/or collection manager. If there is another repeatable expression that is an associated language expression for an option for a complex control that is already part of a repeatable control set, the controls are still given the interactive features of that repeatable expression's collections and not of the collection of repeatable control sets that complex control is contained in. This means the joining expressions and another add/remove controls are added as part of another repeatable expression control set with the appropriate interactivity.

This is useful to highlight or use border changes to signify the inclusion of large groups of controls. For this application all that is required is an iteration through each control, testing for it's use as a repeatable expression control, and then a function call to change appearance. Using the two rules above, every control that is added is either part of the original repeatable control set, or it is represents a repeatable expression that is included in another expression, and with recursion or iteration, the controls can all behave similarly by iterating through them and activating the graphical cues of the repeatable expression control class that have been extended or implemented.

Images 11 through 16 show the flow diagram that describes the use of a control or menu item to add a set of repeatable expression controls. The control or menu item is used at step 206 and then the repeatable expression control factory and/or collection manager are obtained from the repeatable expression control as part of the instructions for block 207.

The build function described before uses a collection passed as a parameter, and when adding a set of controls, they are added to the window and also a collection associated with an option if pertinent. When using the command to add a set of controls, the position of the last repeatable expression control visible on the window is used to establish an index to add controls to the window. The same control is used to find the position of the control in the option control collection at which the new set should be added. In this implementation, a joining expression is added, and then the new repeatable expression control set is added. The complexity is a result of the possibility of an existing repeatable expression the option control is a member of.

The first operation is a conditional expression that tests for an option collection the “More” control could be a member of 208. If it is part of an option, the index of the last control in the set in the window 209 and the collection 210 are found. If it isn't a dependent control, only the index in the window is necessary and those instructions are included in block 212.

After the instructions in block 212 are executed a joining expression control is created and it is added to the repeatable expression control collection manager object's joining expression collection 213. A condition is evaluated at step 214 to determine if there is more than one set of controls managed by that object. There are instructions to iterate through each control in the joining expression control in block 215 and update the index by incrementing it. The control is then added to the window at the updated index by the execution of instructions in block 216.

When the “More” button is pressed, a the option control with the option collection it is a member of is passed as a parameter or just obtained by reference for use. The condition at 211 determines the use of the option control as a repeatable expression control. If it is, the process proceeds to step 217, and if it isn't it proceeds to step 223.

When the option control is a repeatable expression control, the contained management controls like the joining expression controls and the “More” and “Less” button are part of the repeatable expression it belongs to. So, the repeatable expression control factory, the repeatable expression control set manager is taken from that control 217, the repeatable expression control set manager is taken from the control 218 and the collection the option control belongs to is used for the control as well. The process of turning the joining expression control(s) to repeatable expression controls is completed at block 219 when the joining expression is converted and the controls are set as the children or the repeatable expression control properties are extended to them. At block 200 the controls are added to the option control's option collection. If the control is visible 221 the controls are added to the window after the control at the window index set before 222.

When the option control is not a repeatable expression control the joining expression controls are built and added to the option collection after the collection index variable set before 223. If the option control is visible, evaluated by the condition at step 224, the controls are also added to the window in block 225.

That concludes the addition of a joining expression. The addition of the controls for the repeatable expression comes directly after the addition of the joining expression controls. The process is much like the previous processes to convert language elements and handle events. The addition of rules to handle the extension of properties and interactivity and the logic to handle the addition of the controls at the correct position add complexity.

The process that is initiated with a call to a function 226 begins with conditions that establish the type of control created. The condition to determine the type and the instructions to create the control for a word, 227 and 228, a required value 229 and 230, a binary control 231 and 232, a ternary option control 233 and 234, a series option control, 239 and 241, or another repeatable expression, 240, 242, 243 and 244. The last three blocks handle the creation of a new objects to handle repeatable expression controls. In block 242 a repeatable expression control factory is created to store the repeatable expression and joining expression, and the repeatable expression control collection manager is created to handle specific interactivity. Block 243 calls the build function previously covered in image 3. After the controls are built and added to the set of collections handled by the factory and/or manager and the option collection by the build function at block 141 called at block 243, the “More”/“Less” management controls are created and the same conditions and processes are used for the management controls as are used for the other language expression controls. Block 244 includes the instructions to add the “More” button to the option control's option collection if the repeatable expression is contained in a control's option or the window control collection if the repeatable expression is contained.

Block 235 contains instructions for retrieving the control management objects; the factory and/or collection set manager. The execution of instructions in block 236 immediately follow and these could add any control, a label, a text box or input control, a binary option control, a ternary control, a series/combination control or a “More” or “Less” button, to a repeatable expression control.

A test to determine if there are more controls in the collection is run at step 237 and if there aren't any more expressions, since there are no recursive calls to the function, the implementation of the application can implement instructions for a function call, block 238, or proceed directly to an iteration through the repeatable expression control collection to add the controls to the window 245.

The next step is to determine if the control must be added to an option collection or not. After that, the controls are added to the window. To determine if there is a collection to add the controls to the “More” button's option collection can be retrieved for step 246. If the result is true, then an index is calculated.

The index to insert the next repeatable expression control starts at the index of the last repeatable expression control associated with the repeatable expression. The last included repeatable control set is taken, and the index of the last control in that collection is used to initialize the variable 247. Then the index of the current control being added in the repeatable expression control is added to it 248. And then one is added 249. After the value has been updated, the current control is added at the updated index value 250.

After a control is added to the option control collection, it can be added to the window. First the visibility of the option control must be checked at step 251. If it is visible, the index to use to add the control is initialized with the index of the previous repeatable expression control set's last control 252. Then the index of the current control being added in the repeatable expression control is added to it 253. And then one is added 254. After the value has been updated, the current control is added at the updated index value 256.

When there are no more controls the statement at 257 evaluates false and the process ends. If there is another control the processing begins again with a new control at block 246.

Previous hindrances to making a format like this work were the inability to extend the use of collections, link the collection with the visible collections controls and handle extended interactivity like highlighting grouped controls. The previous description describes exactly how this can take place and how functional a format like this with a working architecture can be.

This particular architecture is more aligned with an organization of classes and interfaces facilitating easy maintenance and ease of coding. There are fewer functions required to process through collections of controls, manage visibility of controls and more opportunity for using recursion to process through controls. The controls can extend or implement other functionality and other properties. Establishing other hierarchies to handle the different types of controls in other contexts would not take a significantly higher level of ability.

The overall hierarchy for controls and expressions bears some explaining, and the constructors and execution of changes for the visual controls will be covered.

The hierarchy in image 19 for the example enables the use of the composite pattern to retrieve collections of language elements and expressions if the language expression class implements functions to handle a collection of expressions. The language expression, in this example, is the base class or interface. The language element 288 represents a language element 289 which can consist of a word/phrase 296 or required value 297. The other expressions are the non required expression 290, the required option expression 291, the series option or combination expression 292, the nestable expression 293 which exists to serve as a placeholder, the repeatable expression 294, and the joining expression 295 which is the separator for repeated expression.

The practice of using the composite class is a solution to the problem of handling words and expressions in the complex functions described previously. There are also obvious rules that restrict the kinds of expressions that can be contained in others for the algorithms in place to work. The rules are not enforced using a rigid class hierarchy or data structures and objects in classes, although these could be, but the amount of space and maintenance to implement that kind of solution make this implementation more practical. The rules are shown in image 20, and the block at the end of the connector denotes the inclusion of an expression in that object's collection or in some cases that series of objects' collections.

The statement object 298 is a collection of language expressions. It is a class that can be created using the language expression class or interface. It holds a collection of expressions and there are no rules to what it can have in the collections.

The nestable expression 299 will contain a multiple option expression 300 with its options 303 and language expressions 306, a series option/combination expression 301 with it's options 304 and language expressions 307 or a non required expression 302 and it's option 305 and language expression 308. The reason for the restriction is that a nestable expression, and expression in a tree that could cause a stack overflow because it contains the parent expression, will only occur for these expressions.

The joining expression 309 can contain the expressions that convert to the types of controls that are practical for a joining expression control to manage. These are the required option expression 310 with it's options 313 and the language elements 315 for each option and the non required option expression 311 with its option 314 and the language elements 316 for each option. The joining expression can contain only language elements 312.

More complex expressions could be included in the joining expression. This is up to the user to implement a manageable system of controls. It is generally more practical to include overly complex joining statements in options. For example, if someone is writing a TSQL query with the application the join could be programmed as a joining expression with all of the possible types of joins and hints, or the possible joins could be included as a required option expression in a joining expression and the hints and other complicated syntax could be included in what is technically the next select statement.

The series option/combination expression is not a practical option for a joining expression. This is more practically handled by including it as an option at the end of a statement and joining with a comma, a semicolon or whatever the syntax will accept.

The repeatable expression 317 can contain any kind of expression, and it can contain a joining 321 expression if during the conversion of controls it makes sense to add it as the last expression in it's collection. The required option expression 318, non required expression 319 and series option/combination expression 320 are all practical as well as the language elements 322.

The controls class hierarchy mirrors the language expression hierarchy, and another set of classes must handle the control or control collections that aren't visible like the joining expression control which is really only a complex collection, but it is useful to refer to it as a joining expression control for coding purposes. The visual controls, arbitrarily created and designed, extend a Control Panel class that extends a Composite Language Element Control class. The Composite Language Element Control class implements the Language Element Control interface, the interface from which all expression controls get basic functionality.

The Language Element Control definition 323 extends functionality to the label control 324, the text box for required values 325, a “More”/“Less” Control class 326, a Non Required Option Control class 327, a Multiple Option Control class 328, a Series Option Control class 329 and Repeatable Expression Control 330. The Composite Language Element Control class 331 extends it's functionality to non visible entities that manage controls like the Joining Expression Control class 332, an Option Control Collection class 333, a Repeatable Expression Control Collection class 334 and a Control Panel class 335. The Control Panel class could be just an interface for arbitrarily conceived visual controls that offer functionality to switch on and off (hide and show) an option 336, a ternary control to select an option out of many options that could include a visual queue with a modal dialog box 337, and a multiple selection control with similar functionality as the previous two controls described 338.

One way to summarize the necessity for the class structure is that the language expressions must have a way to to access a visual control, the options that include control collections and the expressions organized as options. The options, so that the functions can be called recursively take the Composite Language Element Control objects as an argument, which can include the non visible classes that get their functionality from that class.

The Control Panel class could exist as a separate group of classes and sub classes, but for this example it makes sense since control could conceivably have multiple controls for iteration and referencing making the functions to manage a composite collection of control necessary.

Image 22 shows the flow diagram of a constructor for a control that represents a word, most commonly conceived as a label, but it could be an image managed by the control. The application can also have options to change which format the user can see. For word control constructor 339 the first instruction is to set the language expression 340, which for this implementation is a language element which can be a word or required value. Any initial text is added 341, any image as a background or representation of a word or phrase is added 342, a text color is chosen 343 and background color are set 344.

Image 23 with FIG. 1 and FIG. 2 shows the constructors for the the non required option control and it's visual binary control. The call to the constructor in FIG. I for a non required option control 345 will call instructions to create a collection for the controls 346. This is managed by the functions implemented from the Composite Language Element Control interface. The language expression is set 347, the background color is set 348 and the visual ternary control is created 349.

FIG. 2 shows the constructor for the ternary control. The functions are typical for a visual control. The call to the constructor 350 is followed by instructions to initialize objects and variables usually seen in a dynamic object modeling or graphic editing application. The text is set for the control 351 and that can mean a new label is created. The controls created by the word or phrase can be managed by the Composite Language Element Control methods that are implemented. Then the background color is set 352, the color of the text is set 353, a variable is set to save the active or inactive state of the control 354, a variable is created and initialized to a value to determine the handling of the default text and/or controls that help identify the visual control of 355 and if the drawing is done immediately for the control or the identifying images can change based on the context instructions are called to build the drawings and/or select images 356.

Image 24 shows a flow diagram that shows the use of a binary control. The interaction starts with the user's interaction with the control 357. The event is processed and a function is called to handle it. The active state is checked and step 358, and if it is initially true the variable is set to false in block 359 and then the functional image and/or text is changed to indicate an inactive state 360. If the active state was initially false, then the variable is set to true 361. The process for that branch is completed after the images and/or text changes to indicate an active state 362. The next step could be placed as a different step and is only included there for the purpose of instruction on how to handle options that change behavior. If a user has chosen to hide the name of a control once it has been hidden, determined by step 363, the identifying, extraneous images and/or labels are removed from the visual control 364. These can be managed by the functions implemented from the Composite Language Element Control interface.

FIG. 3 and FIG. 4 in image 26 handle the construction of a multiple option control. The hierarchy is the same as the other controls. The option control collections are objects that implement the Composite Language Element Control interface and are the Option Control Collection class in the class hierarchy diagram. In FIG. 3 the constructor that builds the control is called at step 365. A collection for option control collections is created in block 366. The language expression is set in block 367. The background color is set 368 and the ternary control is created at 369. The language expression for a required option control will be a required option expression with a collection of option expression, so it is a collection of the same type of expression. When the option collections are created they are assigned the appropriate expression, or the options are at least ordered the same as a collection the of the option expressions.

FIG. 4 shows the diagram for the ternary control constructor. The constructor is called at block 370. The text and/or images to identify the control are set 371, the background color and/or image is set 372

the foreground color is set if text will be drawn 373, the variable that stores the active option is created and initialized 374 and, if the user wants an arbitrarily interactive set of image or scheme that consists of dynamic drawings, those are created in block 375.

Image 27 describes the interactivity for the visual ternary control which starts with the user clicking the control at step 376. A list control could be configured to have a consistent size, and if it is it's scrollable. This is determined at step 377, and if it is not scrollable, it is tested to determine if the list is already expanded 378. At this stage the control could still be scrollable, but it is not the same size if it is active. It the list isn't expanded it is expanded by instructions in block 379 and the step at 380 is carried by the user.

If the list was not expanded and the control can change size when active or it is already expanded the user will select and option at step 380. The active option is changed 381 per the user's selection. If there are images to identify the selection, they are changed by instructions in block 382.

FIG. 5 and FIG. 6 in image 28 diagram the constructors and/or instructions in a build function for the series option/combination control. This control is almost identical in function to the multiple option control. The option control collections are handled the same way.

FIG. 5 shows the diagram for the series option/combination control constructor. The constructor is called 383 and then the values and objects are initialized. The option control collection array list or other collection is created and initialized just like the process for the multiple option control 384. The language expression is set 385, the joining expression is set 386, the background color is set 387 and then the visual combination control is created 388.

FIG. 6 shows the constructor for the visual series option/combination control. The constructor is called 389. The instructions are to set a default text for the control 390, the background image and/or color is set 391, the foreground color for text is set 392, a list to handle active options is created and initialized, and then the drawings and/or images that will change to identify the active options are created 393 and the events initialized as with the multiple option control 394.

The flow diagram in image 29 that shows how a visual series option control change is handled. The begins the change by clicking on the control at step 395. A conditional statement is executed at step 396 to determine if the size of the control will change if it is clicked, since scrolling eliminates the need to resize the control. If it isn't scrollable a test to see if the list is already expanded is done at step 397. If it is not expanded, there are instructions to expand the list for the user so options can be selected 398. After the control is in the correct state for selection the user selects the options at event 399. When the user selects or deselects and option the list of active options is change by instructions in block 400. When the selection is complete the image, text and/or drawing is changed to identify the selected options 401.

The constructor for the “More” and “Less” buttons was not include because it's construction is covered repeatedly in the flow diagrams.

The function that immediately follows the events is diagrammed and starts with image 6 where a control is changed.

FIG. 7 shows the execution of instructions to extend or implement functions to add interactive features to a control to make it behave in the same way as other controls in a repeatable expression control set. The features are added in the constructor or another function called in the constructor 402. After the call to the constructor, the control object is set to whichever kind of control is passed to the constructor at block 403. After the control is set, events and features are added like highlighted windows that cover the control, borders and anything else the developer might want 404. Next the instruction to show the control are executed and if the paint method can be used to add interactivity it is called along with the visual control's paint method 405.

The use of the repeatable expression control collection management buttons is covered extensively already, but FIG. 8 is a a summarized description of instructions executed when a “More” management button is clicked. The user clicks the “More” button at event 406, the repeatable expression control factory creates the controls, and then a process summarized in block 407 that begins in image 11.

The “Less” manage button flow diagram in FIG. 9 uses the same objects as the “More” button, but it removes the controls in the last repeatable expression control collection from the window and any other collections. The removal instructions that begin at block 176 on page 7 contains most of the logic to remove controls from a collection. If the repeatable expression can be passed as a parameter, most of those instructions can be carried out to remove the controls. The user will make a choice to remove a repeatable expression control set at event 408. Block 409 summarizes the process. The controls in the collection are iterated through and removed from the window, using a recursive algorithm to find all of the sub controls. The joining expression control before or after the set of controls is removed from the window and the joining expression control collection of the repeatable expression control factory. The controls are removed from the option control collection that contains them using the same functions to remove them from the window. The joining expression controls are removed from the option collection as well. After the controls are removed from the window and the option control collection, the repeatable expression control set is removed from the array list or generic collection object.

The use of shortcut keys are diagrammed in FIG. 10 and are included as part of context 70 where a user changes controls to edit a statement. A control would be selected and a shortcut key could open the control or change the active state of the control. Those commands could be saved as instructions as part of block 410. When the shortcut key is used when a control has focus 411. The instructions are executed as part of block 412.

FIG. 11 diagrams the use of a menu or context menu t change the themes that change the appearance of the application. This relates to context 90 and 100 where the appearance of the application can change based on an option change. A user changes an option at event 413 and the instructions at 414 change settings handled by classes that extend functionality or they set variables that change the execution of functions that handle storing state information and resetting controls to a default state.

When a user opens a file as part of context 40, the flow diagram shown in FIG. 12 is executed. The user opens a file as part of event 415 and the instructions at block 416 that open a list of saved work progress and expressions that can be converted back to controls.

Context 130, in which a user opts to save a file containing current work progress. The user selects the menu item or uses a button to open a menu to set a file name and location for the file at event 417. Instructions to open a save file dialog with a button to save the file are opened as part of the instructions for block 418. The user chooses to the save the file at the specified location by confirming at event 419. Then the control state is converted to language expression elements or serial text in block 420. The instructions for this process consist of context 140, where the controls are converted and saved.

Context 90 includes several other configuration options and preferences menus that change the UI configuration and preferences not related to themes that change the appearance of all controls. The UI configuration consists of a series of windows that can be added or removed with the selection of options in a menu. The windows can include the option controls and filter them out of the main editing window. This is easily done by iterating through the controls and creating separate collections, while the controls can exist in another hidden window collection, using the same algorithms described above for editing. The user could also drag controls to another window as a method to bookmark locations or for commenting. The user would select an option from the UI configuration menu at event 421, and the windows would be added 422 as dockable windows or configured in a predetermined view. The variables and algorithms to indent and show form in the windows could be turned on or off 423.

If a user wants to change the overall look of the controls and the windows, the menus to change preferences is available, and the user would select preferences with event 424. The changes can be made immediately with the use of variables that affect the editing window and the positioning of the different windows 425.

Image 34 shows the use of navigation keys. The speed of development available with an editor that generates phrases and variables may still be offset by the inability to navigate if there isn't a programmable way to move through the changeable form controls. The tab key and shortcut keys can manage this along with the arrow keys that would be limited to forward and backward functions. Shift and tab could navigate back through controls. When navigation control by control the user uses the shift key or arrow key at event 426. The check for a control with focus is performed at step 427. If there isn't a control with focus in the editing window, the first control is obtained in block 428. If the shift key is pressed while the tab key is used, or if the back arrow is pressed, the previous control receives focus 430. If not, the next control receives focus 431.

There are many options that could change the behavior of navigation keys. The tab key could iterate through changeable controls of the same type at the same level, or any changeable control of the same type. Page up and page down keys could scroll through areas of the editing window and end and home could focus on the first and last key of an option's collection, repeatable expression control set, the containing collection of controls or the first control in the window depending on keys that can modify the instructions like Alt, Ctrl and Shift.

Image 35 shows the interactive functionality in use using a mouse over event. The user mouses over a control at step 432. If the control is a repeatable expression control, determined by the condition at 433. The instructions in block 434 can include instructions to get the included option controls and the related option controls. The purpose is to use the the iteration to enable the interactive cues for visible controls that set the collection apart from the rest of the program or statement.

Image 36 and 37 show algorithms for handling assistance for the common programming features like nested features and complex conditions. These are both part of context 70 where the user chooses to change a control to edit a statement. The two algorithms are important for showing the efficacy of extending the functionality of the control collections and methods to convert language expressions to controls.

The nested function problem is solved by using a nestable expression and a maintainable list of functions. The functions can be indexed with unique names and/or included in the same or separate language specification by each list of possible parameters and return type. In image 36 the method involves inserting a new required option control with a list of functions. So, one of the parameters will have to be an acceptable parameter for the required value, and the return type will have to be one of the valid parameter types of the previously selected function. These lists can obviously be reset when either option control is changed or removed from the editing window.

The first step to the process is the addition of a required option control, a left parenthesis, a required option control with a language expression that is nestable, a required value control and a right parenthesis in block 435. The nestable expression is given a label or name 436 to direct a process to retrieve the correct functions for the required option control if the required option control is clicked at event 437. When the control is clicked the expression is built and converted using the retrieved functions based on the value type name given to the nestable expression 437 with a required value control as a potential option. A list of available functions will have to be managed 438 each time the required option is clicked by using a dynamic list of functions or a language expression is functions and an algorithm to sort and filter the functions by name, return type and parameter types. A new nestable expression will be included for any required value used as a parameter for the new function based on variable type 439. The list of available functions for the newly include nestable expression, based on the value type it is used for is then managed 440.

Complex conditional statements are a very complex and difficult aspect of programming that often lead to errors and repeated testing. The flow diagram in image 37 shows how to build these, and it is not an unfamiliar way to build conditional statements. The instructions in block 441 add a “single” option and a “multiple” option. The single option includes a non required option with the word “Not” 442 and a conditional statement. The multiple option will include a non required option with the word “Not” and enclosed in parentheses the completed required option control 443, with the single and multiple option, as a repeatable expression control.

So, the user will see a required option control with the choices “single” and “multiple”. If the user selects “single” An optional “Not” will be shown and two required value controls with a required option that selects a boolean operator in between the values will be shown. If the user selects “multiple” 444 the optional “Not” will appear, and after that a copy of the entire required option control will be shown 445 enclosed in parentheses with a “More” button. If the user selects the “More” button, a required option control with operators “AND” and “OR” could show before the next copy of the required option control.

While the algorithms may not be novel, it is proof of concept that the existing architecture can facilitate any kind of syntax.

Image 38 shows a generic conversion of controls to a text language specification as part of context 140. A specification could be hierarchical and handled with XML or a text version with brackets and braces to enclose the types of expressions. The algorithm is recursive so the structure of the expression will be kept in the text file. A call is made to a function to iterate through control in a collection pass as a parameter as part of the instructions executed in 446.

The first test on the control is the test for a repeatable expression control 447. If it is a repeatable expression control there are more tests. First, to see if the control is in the first collection 448. If it is in the first repeatable expression control set, instructions in block 449 add the repeatable expression and joining expression to the file. After the instructions are executed a conditional statement is evaluated at event 450 to determine if it is the first control in it's set. If it is, then the set index and information is saved to the file as part of the instructions in block 451. The child or contained control is obtained by the instructions in block 452.

The path after the language expression control is obtained from the repeatable expression control joins with the path of a control that is determined not to be a repeatable expression control. The test to see if the control is a simple control with a language element or a complex control with a language expression is run. The first evaluation determining if it is a label or a text box at 453 and the test for a complex control at 454. The language expression which includes all of the language expressions for all of the options, default name and active option index for the complex control is saved to the text file in block 455. Then, the options are iterated through 456 with any necessary information for that option saved to the text file 457, and the function is called again using the option collection in block. A condition is evaluated to see if there is another collection at step 458. if there isn't the function ends, and, if there is, the process finds the next option collection to evaluate.

The new method and system uses an arbitrary language specification organized as a series of words and characters or a hierarchical list of elements converted to a collection of inline controls to generate and modify any code or symbols using one or more windows. The controls are added to one or more windows depending on the user's choice of how to view/use the changeable controls; inline or in another window that functions as a structured, indented outline so the user can manage controls outside the default editing window. A composite class pattern for expression types and extended controls extends interactivity, and makes a scalable API possible. Word, required value, binary option, ternary option, series option, repeatable and nested, or recursively repeating, expressions are included in the class structure, making any command or syntax possible.

1. A non-transitory tangible computer-readable medium having computer-executable instructions for implementing a method of syntax construction using a language definition converted to a collection of controls in a single window or multiple windows, the computer executable instructions comprising instructions for:
converting a language definition or specification and providing a series of controls that represent at least a command, the language specification comprising at least elements in a statement in a coding language or natural language;
converting a series of controls to a language definition or specification with language comprising at least elements in a statement in the coding language or natural language;
defining a language specification as any language specification, language definition or any subset of either, wherein the programming command comprises at least one expression;
providing components corresponding to each language element and components to generate expressions corresponding to each changeable feature in the language specification;
receiving data relating to a value for a required value;
receiving data relating to a change in the state of a control;
receiving data relating to a change a the appearance or interactivity of any set of controls;
receiving data relating to a change in position of a control;
extracting a statement, wherein all label and text box values comprise a completed statement;
wherein the computer executable instructions for defining the statement comprise instructions for:
modifying a text box;
changing the state of a any type of binary control;
changing the selected option of any type of list control;
changing the active option(s) of any type of combination control; and
using any control type to add or remove a predefined or newly converted set of dependant controls.
